(19) United States
(12) Patent Application Publication
(10) Pub. No.: US 2004/0044470 A1
(43) Pub. Date: Mar. 4, 2004

(54) Method for route guidance, and terminal equipment and central apparatus for use therein

(76) Inventors: Ryousuke Matsuoka, Kobe-shi (JP); Shinichi Hayashi, Kobe-shi (JP); Akihiko Shiotani, Kobe-shi (JP); Masahiko Kitagawa, Kobe-shi (JP); Kuniaki Kashiwagi, Kobe-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/445,659

(22) Filed: May 27, 2003

(30) Foreign Application Priority Data
May 31, 2002 (JP) 2002-159765

(51) Int. Cl. G01C 21/30

(52) U.S. Cl. 701/209; 701/210; 340/995.12

(57) ABSTRACT

Terminal equipment receives map image information from a central apparatus along with recommended-route information generated by the central apparatus and presenting a recommended route leading from present position to destination, and the terminal equipment displays both the map information and the recommended-route information. When it is detected that the terminal equipment has deviated from the recommended route, the present position of the terminal equipment is transmitted to the central apparatus, and the central apparatus, based on the received present position, searches for a new route and transmits newly generated recommended-route information to the terminal equipment, which displays the newly received recommended route by superimposing it onto the already received map.

### BACKGROUND OF THE INVENTION

1. Field of the Invention

The present invention relates to a method for route guidance, and terminal equipment and a central apparatus for use therein, wherein map data and route guidance data are transmitted separately from the central apparatus equipped with a map database to the terminal equipment over a network so that the data can be displayed on the terminal equipment by superimposing one on the other.

2. Description of the Related Art

There has been developed a network-based navigation system that transmits map data and a route to a destination from a central apparatus equipped with a map database to terminal equipment over a network.

Further, Japanese Unexamined Patent Publication No. 2000-251196 discloses transmitting separately route information and route additional information from a central apparatus to terminal equipment and displaying them on the terminal equipment by superimposing one onto another.

The present invention is directed to the provision of a method for route guidance using a network, that can reduce the amount of data for transmission as much as possible when transmitting route guidance information from the central apparatus to terminal equipment and yet can provide guidance information responding to changing situations in real time; the invention is also directed to the provision of the terminal equipment and the central apparatus for use therein.

### SUMMARY OF THE INVENTION

According to the present invention, there is provided a method for route guidance in which terminal equipment transmits its present position and a destination to a central apparatus, receives map image information from the central apparatus along with recommended-route information generated by the central apparatus and presenting a recommended route leading from the present position to the destination, and displays both the map image information and the recommended-route information.

When the terminal equipment recognizes that the present position is off the recommended route, the terminal equipment transmits its present position to the central apparatus, receives information of a recommended route newly searched for by the central apparatus, and displays the new recommended-route information together with the already received map image information.

The terminal equipment transmits its present position to the central apparatus at predetermined intervals of time or at appropriate intervals of time and, when the central apparatus recognizes that the present position is off the route, the terminal equipment receives information of a recommended route newly searched for based on that present position, and displays the new recommended-route information together with the already received map image information.

When the central apparatus obtains information concerning a traffic impediment that exists on the recommended route along which the terminal equipment is moving, the terminal equipment receives information of a recommended route newly searched for and generated by the central apparatus so as to detour around the traffic impediment, and the terminal equipment displays the new recommended-route information together with the already received map image information.

Of the information concerning the recommended route newly searched for by the central apparatus, the terminal equipment receives only a portion not included in the original recommended-route information, and displays both the map image information and the recommended-route information.

The map image information and the recommended-route information are stored in the central apparatus by being divided into a plurality of portions, and the terminal equipment receives the divided portions in sequence based on the present position of the terminal equipment.

The map image information and the recommended-route information are divided at an intersection halfway along the recommended route.

The map image information and the recommended-route information are divided at prescribed intervals of distance along the recommended route.

According to the present invention, there is also provided terminal equipment which transmits the present position of the terminal equipment and a destination to a central apparatus, receives map image information from the central apparatus along with recommended-route information generated by the central apparatus and presenting a recommended route leading from the present position of the terminal equipment to the destination, and displays both the map image information and the recommended-route information.

When the terminal equipment recognizes that the present position is off the recommended route, the terminal equipment transmits its present position to the central apparatus, receives information of a recommended route newly searched for by the central apparatus, and displays the new recommended-route information together with the already received map image information.

The terminal equipment transmits its present position to the central apparatus at predetermined intervals of time or at appropriate intervals of time and, when the central apparatus recognizes that the present position is off the route, the terminal equipment receives information of a recommended route newly searched for by the central apparatus based on that present position, and displays the new recommended-route information together with the already received map image information.

When the central apparatus obtains information concerning a traffic impediment that exists on the recommended route along which the terminal equipment is moving, the terminal equipment receives information of a recommended route newly searched for and generated by the central apparatus so as to detour around the traffic impediment, and the terminal equipment displays the new recommended-route information together with the already received map image information.

Of the information concerning the recommended route newly searched for by the central apparatus, the terminal equipment receives only a portion not included in the original recommended-route information, and displays both the map image information and the recommended-route information.

The map image information and the recommended-route information are stored in the central apparatus by being divided into a plurality of portions, and the terminal equipment receives the divided portions in sequence based on the present position.

The map image information and the recommended-route information are divided at an intersection halfway along the recommended route.

The map image information and the recommended-route information are divided at prescribed intervals of distance along the recommended route.

According to the present invention, there is also provided a central apparatus which receives from terminal equipment the present position of the terminal equipment and a destination, generates recommended-route information by searching for a route leading from the received present position to the destination, and transmits map image information to the terminal equipment along with the recommended-route information presenting the recommended route leading from the present position to the destination.

When the terminal equipment recognizes that the present position of the terminal equipment is off the recommended route, the central apparatus receives the present position of the equipped vehicle transmitted from the terminal equipment, and generates and transmits information of a newly searched-for recommended route.

The central apparatus receives the present position of the terminal equipment from the terminal equipment at predetermined intervals of time or at appropriate intervals of time and, when the central apparatus recognizes that the present position is off the route, the central apparatus generates and transmits information of a recommended route newly searched for based on the present position.

The central apparatus, based on information concerning a traffic impediment, newly searches for a recommended route so as to detour around the traffic impediment, and generates and transmits information of the newly searched-for recommended route.

Of the information concerning the newly searched-for recommended route, the central apparatus generates and transmits only a portion not included in the original recommended-route information.

The central apparatus stores therein the map image information and the recommended-route information by dividing the respective information into a plurality of portions, and transmits the divided portions in sequence based on the present position of the terminal equipment.

The map image information and the recommended-route information are divided at an intersection halfway along the recommended route.

The map image information and the recommended-route information are divided at prescribed intervals of distance along the recommended route.

According to the method for route guidance and the terminal equipment of the present invention, the map image information and the recommended-route information generated by the central apparatus and presenting the recommended route from the present position to the destination are received as separate files.

According to the center apparatus of the present invention, the map image information and the recommended-route information presenting the recommended route from the present position to the destination are transmitted as separate files to the terminal equipment.

According to the present invention, there is also provided a method for route guidance in which terminal equipment transmits its present position and a destination to a central apparatus, receives map image information from the central apparatus along with recommended-route information generated by the central apparatus and presenting a recommended route leading from the present position to the destination, and displays the map image information and the recommended-route information by superimposing one onto the other.

When the terminal equipment transmits its present position and the destination to the central apparatus, the terminal equipment also transmits routes that the terminal equipment has passed in the past, and receives the recommended-route information that the central apparatus generated by considering the frequency of use of the routes.

According to the present invention, there is also provided a method for route guidance in which terminal equipment transmits its present position and a destination to a central apparatus, and receives, from the central apparatus, map image information generated by the central apparatus by writing on a map a recommended route leading from the present position to the destination.

The terminal equipment receives only a map of a region in the vicinity of the recommended route that the central apparatus extracted from the map image information.

According to the present invention, when a new route is searched for in order to avoid traffic congestion or in the event of the terminal equipment deviating from the recommended route, only the newly searched-for route needs to be transmitted from the center to the terminal; this not only facilitates new route searching but also serves to reduce the amount of data for transmission.

Furthermore, by transmitting the route guidance information from the center to the terminal by dividing the information into smaller portions, the time required for downloading at the terminal can be reduced even when the destination is a long distance away. Moreover, when the destination is changed on the way, the already transmitted data is not wasted.

Further, since the recommended route is generated by considering the routes along which the vehicle equipped with the terminal has frequently traveled in the past, route guidance easy to use by the user can be provided.

Also, by transmitting only a map of the region in the vicinity of the recommended route, not the entire map image, or by using a map stored in the terminal, the amount of map data to be transmitted can be reduced.

According to the present invention, there is also provided terminal equipment comprising: a position detecting section for detecting the present position of the terminal equipment; a communication section for communicating with a central apparatus; a map image information storing section for storing map image information received via the communication section from the central apparatus; and a map image information combining section for combining the image information with recommended-route information received via the communication section from the central apparatus wherein, when the position detecting section detects that the present position is off the route, the map image information combining section receives image information of a recommended route, newly searched for by the central apparatus, and combines the new recommended-route image information with the already received map image information.

According to the present invention, there is also provided a central apparatus comprising: a communication section for communicating information to and from terminal equipment; a map database having map image information stored therein; and a route searching section for searching for a recommended route based on the present position of the terminal equipment and a destination received via the communication section, wherein information of the recommended route searched for by the route searching section is transmitted along with the map image information retrieved from the map database and, when the communication section receives information indicating that the terminal equipment has deviated from the recommended route, information of a newly searched-for recommended route is transmitted from the communication section without re-transmitting the map image information.

It will be noted that the “terminal equipment” used in the present invention refers not only to automotive terminal equipment but also to other terminal equipment, such as a portable telephone and a personal computer, that can be used in the present invention.

### BRIEF DESCRIPTION OF THE DRAWINGS

FIG. 1 is a diagram schematically showing the system configuration of the present invention.

FIG. 2 is a diagram illustrating a procedure for a terminal to acquire a map and route guidance information from a center in the system of FIG. 1.

FIGS. 3A to 3C are diagrams showing examples of a retrieved map and a generated recommended route.

FIG. 4 is a diagram illustrating a procedure according to a first embodiment.

FIGS. 5A to 5C are diagrams showing an example of a new recommended route that the center transmits to the terminal based on the new position of the terminal when the equipped vehicle traveling along the route has deviated from the original recommended route.

FIG. 6 is a diagram illustrating a procedure according to a second embodiment.

FIG. 7 is a diagram illustrating a procedure according to a third embodiment.

FIG. 8 is a diagram illustrating a procedure according to a fourth embodiment.

FIG. 9 is a diagram showing how route guidance data is divided.

FIG. 10 is a diagram showing how route guidance data is divided.

FIG. 11 is a diagram illustrating a procedure according to a fifth embodiment.

FIG. 12 is a diagram illustrating a procedure according to a sixth embodiment.

FIG. 13 is a diagram showing an example of an NVML file.

FIG. 14 is a diagram illustrating a procedure according to a seventh embodiment.

FIG. 15 is a diagram illustrating a procedure according to an eighth embodiment.

FIGS. 16A and 16B are diagrams each showing a map containing the recommended route to be transmitted to the terminal equipment.

FIG. 17 is a diagram illustrating a procedure according to a ninth embodiment.

FIG. 18 is a diagram illustrating a procedure according to a 10th embodiment.

FIGS. 19A and 19D are diagrams showing heading-up maps and text information.

### DETAILED DESCRIPTION OF THE PREFERRED EMBODIMENTS

Embodiments of the present invention will be described in detail below with reference to the accompanying drawings.

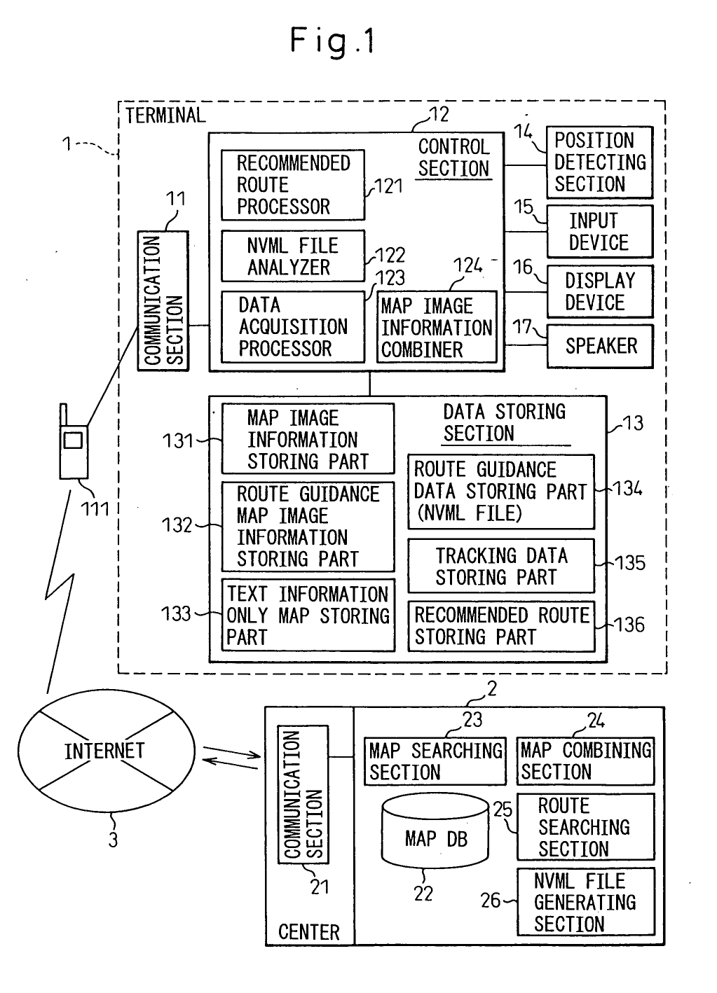

FIG. 1 is a diagram schematically showing the system configuration of the present invention. As shown in FIG. 1, the system comprises terminal equipment 1 (hereinafter simply the “terminal”) and a central apparatus 2 (hereinafter simply the “center”) which are configured to be able to transmit and receive information between them via a network 3 such as the Internet.

The terminal 1 comprises a communication section 11 for transmitting and receiving information to and from the center 2 via the network 3 such as the Internet, a control section 12, a data storing section 13, a position detecting section 14 such as a GPS receiver for detecting the position of the terminal 1, an input device 15 for inputting departure point, destination, etc., a display device 16 for displaying recommended routes, maps, etc., and a speaker 17 for voice guidance, etc. A portable telephone 111 can be used as the communication section 11. The terminal control section 12 includes a recommended route processor 121, an NVML file analyzer 122, a data acquisition processor 123, and a map image combiner 124. The data storing section includes a map image information storing part 131, a route guidance map image information storing part 132, a text information only map storing part 133, a route guidance data (NVML file) storing part 134, a tracking data storing part 135, and a recommended route storing part 136. The NVML (Navigation Markup Language) is an XML (extensible Markup Language) based language for describing information necessary for route guidance.

The center 1 includes a communication section 21, a map database 22, a map searching section 23, a map combining section 24, a route searching section 25, and an NVML file generating section 26.

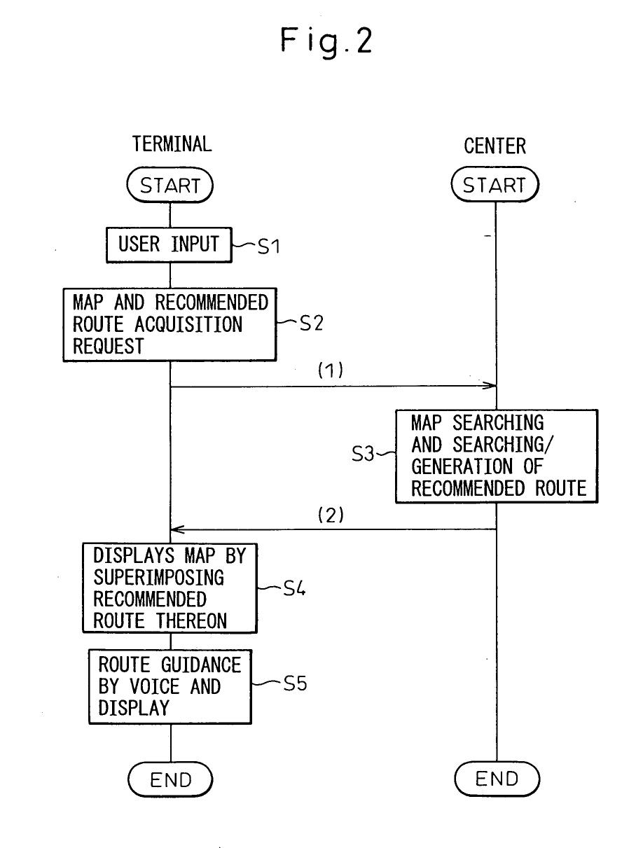

FIG. 2 is a flowchart illustrating a procedure for the terminal 1 to acquire a map and route guidance information from the center 2 in the system of FIG. 1. First, the user inputs the present position of the terminal and the desired destination from the input device 15 of the terminal 1 (S1), and requests the center for transmission of a map and a recommended route (S2). This request is transmitted from the control section 12 to the center 2 over the network 3 via the communication section 11, together with the latitudes and longitudes of the terminals present position and the destination ((1)). The center 2 receives these data by the communication section 21 and transfers the data to the map searching section 23 and the route searching section 25. The map searching section 23, based on the latitudes and longitudes of the present position and the destination, searches the map database 22 for a map of the region containing the present position and the destination, while the route searching section 25, based on the latitudes and longitudes of the present position and the destination, searches for a route, and the recommended route thus searched for is generated in the form of a transmissive image (S3). The retrieved map and the recommended route generated in the form of a transmissive image are transmitted as separate files ((2)).

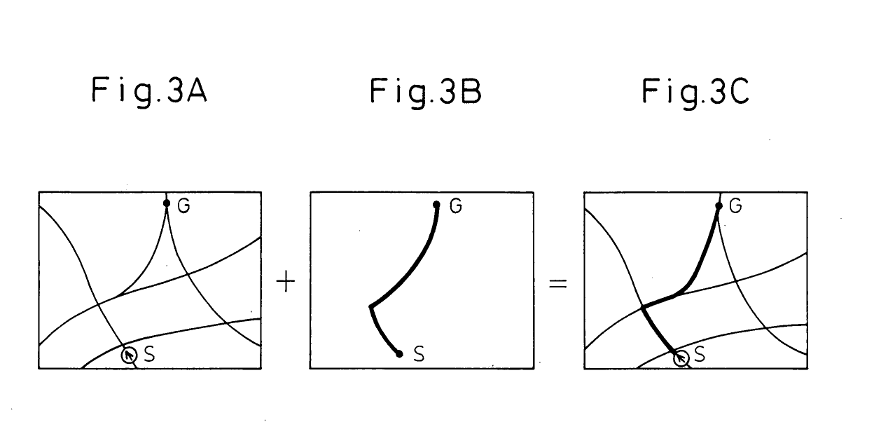

FIGS. 3A to 3C are diagrams showing examples of the retrieved map and the generated recommended route; in the figures, S is the present position as the departure point, and G is the destination. FIG. 3A shows the map data, and FIG. 3B shows the recommended route searched for and generated in the form of a transmissive image; these data are transmitted as separate files to the terminal.

The terminal 1 receives the map data and the recommended route, which are then processed in the data acquisition processor 123 and the recommended route processor 121, are combined in the map image information combiner 124, and are displayed on terminal's display device 16 by superimposing the recommended route of FIG. 3B on the map of FIG. 3A. The recommended route of FIG. 3B is created in the form of a transmissive image so that the portions other than the route are transparent and, when the image is superimposed on the map of FIG. 3B, the recommended route is displayed on the map as shown in FIG. 3C (S4). During traveling along the route, route guidance is presented by means of voice or display (S5).

(Embodiment 1)

Usually, the map data and the recommended route are acquired in accordance with the above procedure, but there are cases where the vehicle, while traveling along the route, deviates from the recommended route. In such cases, in the present invention, a new recommended route is transmitted from the center as will be described below.

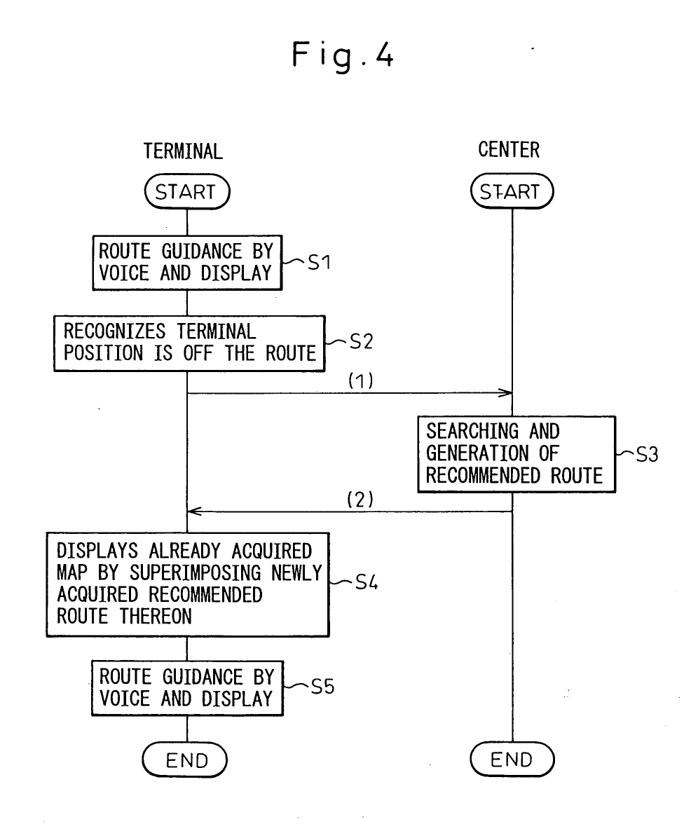

FIG. 4 is a diagram illustrating a procedure for transmitting a new recommended route from the center based on the new position of the vehicle that has deviated from the original recommended route while traveling along the route. When the vehicle is traveling along the route in accordance with the guidance (S1), if the terminal recognizes that the vehicle has deviated from the recommended route (S2), the terminal transmits the vehicle's present position (latitude and longitude) and a recommended route search request to the center ((1)). Upon receiving these data, the center searches for a new recommended route based on the present position of the terminal, and generates a transmissive image of the recommended route based on the search result (S3). The thus generated recommended route is transmitted to the terminal ((2)). At the terminal, the newly acquired recommended route is displayed by superimposing it on the already acquired map (S4), and the route guidance is resumed (S5). In this case, the original recommended route may be erased from the map or, if necessary, may be left on the map. In the latter case, the newly acquired recommended route may be displayed, for example, in a different color to make it more clearly distinguishable from the original one.

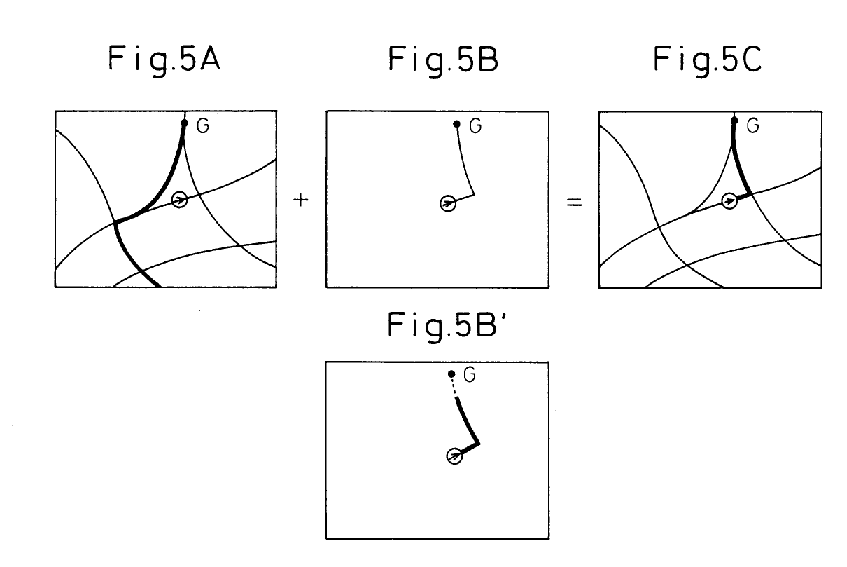

FIGS. 5A to 5C are diagrams showing an example of the new recommended route that the center 2 transmits to the terminal 1 based on the new position of the terminal when the equipped vehicle traveling along the route has deviated from the original recommended route. When the vehicle has deviated, as shown by an arrow, from the recommended route indicated by thick line in FIG. 5A, the center searches for a new route based on the position indicated by the arrow and transmitted from the terminal. As a result, the recommended route shown in FIG. 5B is retrieved. In such a case, in the present invention, only the recommended route shown in FIG. 5B is transmitted to the terminal. At the terminal, the newly received transmissive image of the recommended route is superimposed on the already received map, and displayed as shown in FIG. 5C.

In FIG. 5B, the recommended route up to the destination is retrieved and transmitted to the terminal but, alternatively, only the portion not included in the original recommended route may be transmitted, as shown by a solid line in FIG. 5B′. In the latter case, the segments of the route not included in the original recommended route may be displayed, for example, in a different color on the previously transmitted map displayed with the recommended route superimposed thereon.

In the above description, the terminal recognizes that the vehicle has deviated from the route but, alternatively, upon noticing that the vehicle has deviated, the user may input the present position of the terminal and a recommended route request from the input device of the terminal for transmission to the center.

(Embodiment 2)

In the first embodiment, when the terminal recognizes that the equipped vehicle has deviated from the recommended route while traveling along the route in accordance with the guidance (S1), the position (latitude and longitude) of the vehicle and the recommended route search request are transmitted from the terminal to the center.

In a second embodiment, on the other hand, the terminal transmits its present position to the center at predetermined intervals of time or at appropriate intervals of time and, when the center recognizes that the position of the terminal is off the route, the center searches for a new recommended route and generates the recommended route based on the search result.

Here, the term “predetermined intervals” means that the interval is fixed to an arbitrary time, for example, 30 minutes. On the other hand, the term “appropriate intervals” means equal intervals but the interval is not fixed. For example, in the daytime, the interval is set to 15 minutes, and in the nighttime, the interval is set to 30 minutes.

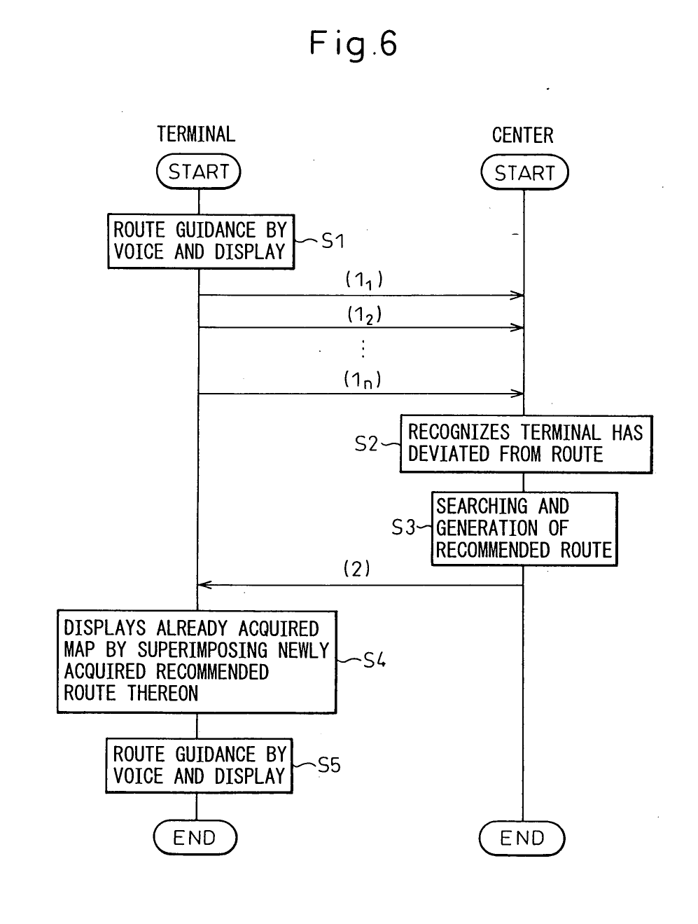

FIG. 6 is a diagram illustrating a procedure according to the second embodiment. When the vehicle equipped with the terminal is traveling along the route in accordance with the guidance (S1), the terminal transmits the latitude and longitude of its present position to the center at predetermined intervals of time ((1₁), (1₂), . . . , (1ₙ)). When the center that received the data recognizes that the terminal has deviated from the recommended route (S2), the center searches for a new recommended route based on the present position of the terminal, and generates a transmissive image of the recommended route based on the search result (S3). The generated recommended route is transmitted to the terminal ((2)). At the terminal, the newly acquired recommended route is displayed by superimposing it on the already acquired map (S4), and the route guidance is resumed (S5). In this case, the original recommended route may be erased from the map display or, if necessary, may be left thereon, for example, by changing its color. Here, as described in the first embodiment, only the portion not included in the original recommended route may be transmitted to the terminal for display.

(Embodiment 3)

In a third embodiment, when the vehicle is traveling along the recommended route, if the center obtains information concerning a traffic impediment, such temporary road closure or traffic congestion, along the recommended route, the center searches for a route that detours around the road closure, traffic congestion, etc. and transmits to the terminal a transmissive image of the recommended route generated based on the search result.

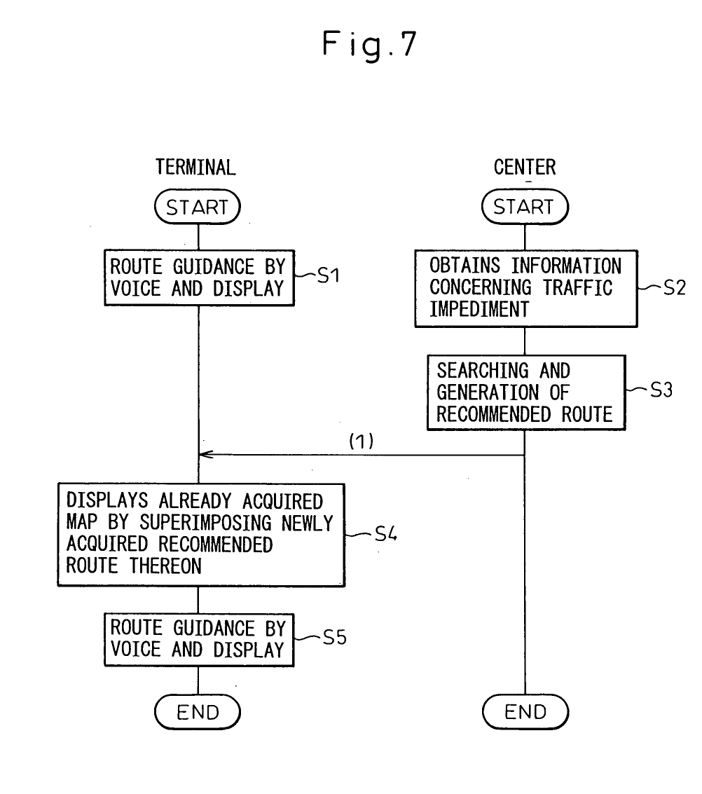

FIG. 7 is a diagram illustrating a procedure according to the third embodiment. When the vehicle equipped with the terminal is traveling along the route in accordance with the guidance (S1), if the center obtains information concerning a traffic impediment, such temporary road closure or traffic congestion, along the recommended route (S2), the center searches for a route that detours around the road closure, traffic congestion, etc. and generates a transmissive image of the recommended route based on the search result (S3). In this case, the route search may be conducted based on the terminals present position received from the moving terminal, or based on the initially received present position and the destination. The generated recommended route is transmitted to the terminal ((1)). At the terminal, the original recommended route is erased from the display, the newly acquired recommended route is displayed by superimposing it on the already acquired map (S4), and the route guidance is resumed (S5). Here, the newly acquired recommended route may be displayed in superimposing fashion, for example, by changing its color but without erasing the original recommended route. Further, as described in the first embodiment, only the portion not included in the original recommended route may be transmitted to the terminal for display.

(Embodiment 4)

In a fourth embodiment, the destination and the recommended route for the terminal are stored and managed at the center, and the recommended route data is transmitted to the terminal by dividing the data into smaller portions.

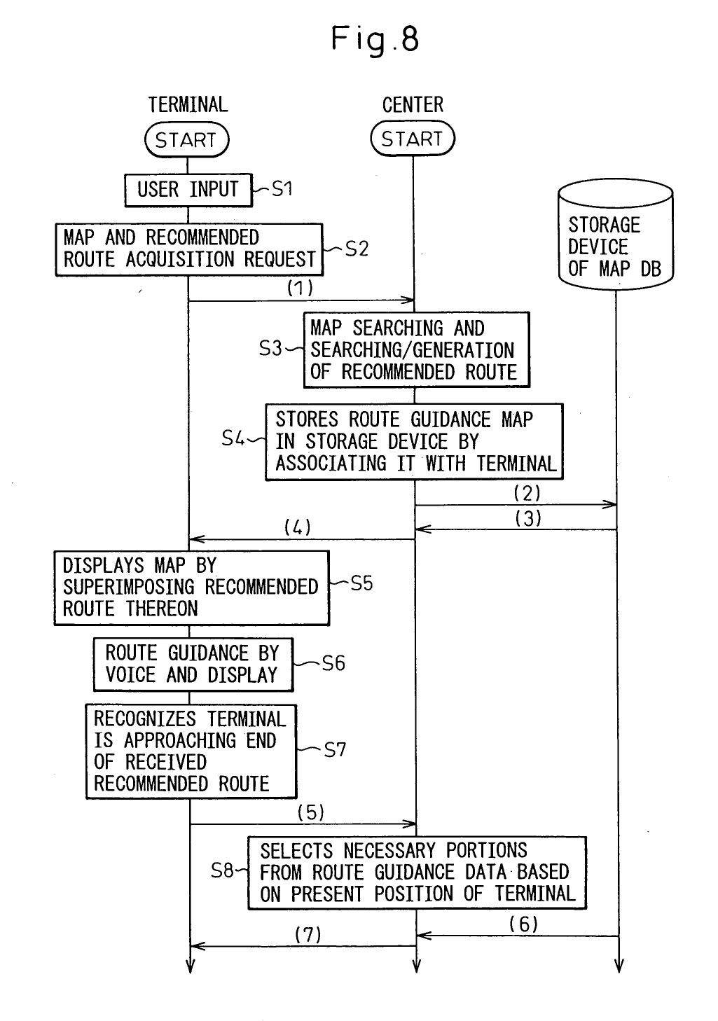

FIG. 8 is a diagram illustrating a procedure according to the fourth embodiment. First, the user inputs the present position of the terminal and the desired destination from the input device 15 of the terminal 1 (S1), and requests the center for transmission of a map and a recommended route (S2). This request is transmitted from the control section 12 to the center 2 over the network 3 via the communication section 11, together with the latitudes and longitudes of the terminal's present position and the destination ((1)). The center 2 receives these data by the communication section 21 and transfers the data to the map searching section 23 and the route searching section 25. The map searching section 23, based on the latitudes and longitudes of the present position and the destination, searches the map database 22 for a map of the region containing the present position and the destination, while the route searching section 25, based on the latitudes and longitudes of the present position and the destination, searches for a route, and the recommended route thus searched for is generated in the form of a transmissive image (S3). Next, the center stores the map and the generated recommended route, as the route guidance data for the terminal, in a storage device of the map database 22 (S4). The map and the recommended route are stored by being divided into smaller portions. The recommended route is stored in the map database storage device by being associated with the terminal ((2)). Next, based on the latitude and longitude of the terminal's present position, the center selects necessary portions from the divided map data and recommended route stored in the storage device, and outputs the selected portions ((3)). The selected portions of the map and recommended route are transmitted as separate files from the center to the terminal ((4)). The terminal that received them produces the display by superimposing the selected portion of the recommended route on the selected portion of the map (S5). Then, the route guidance is produced by voice and display (S6).

When the terminal recognizes that the vehicle traveling along the recommended route is approaching the end of the received recommended route (S7), the terminal transmits the latitude and longitude of its present position to the center ((5)); then, based on the latitude and longitude of the terminal's present position, the center selects necessary portions from the divided map and recommended route data stored in the map database for the terminal (S8), and retrieves the selected portions from the map database storage device ((6)). The selected portions of the map and route guidance data are transmitted from the center to the terminal ((7)), and the terminal that received them produces the display by superimposing the selected portion of the recommended route on the selected portion of the map. The above procedure is repeated until the vehicle equipped with the terminal arrives at the destination.

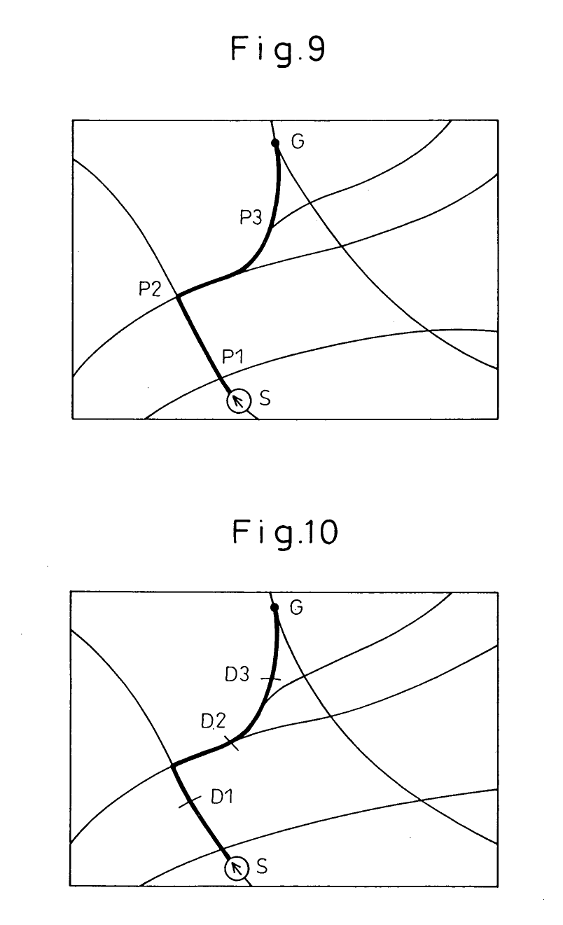

FIGS. 9 and 10 are diagrams showing how the route guidance data is divided. In FIG. 9, the recommended route from the departure point S to the destination G is divided at an intersection. In FIG. 10, the route is divided at prescribed intervals of distance, for example, 5 km.

(Embodiment 5)

In a fifth embodiment, when requesting a recommended route search, tracking data recording the routes along which the equipped vehicle has traveled in the past is transmitted to the center so that the center can search for a recommended route by considering the routes that the user frequently uses.

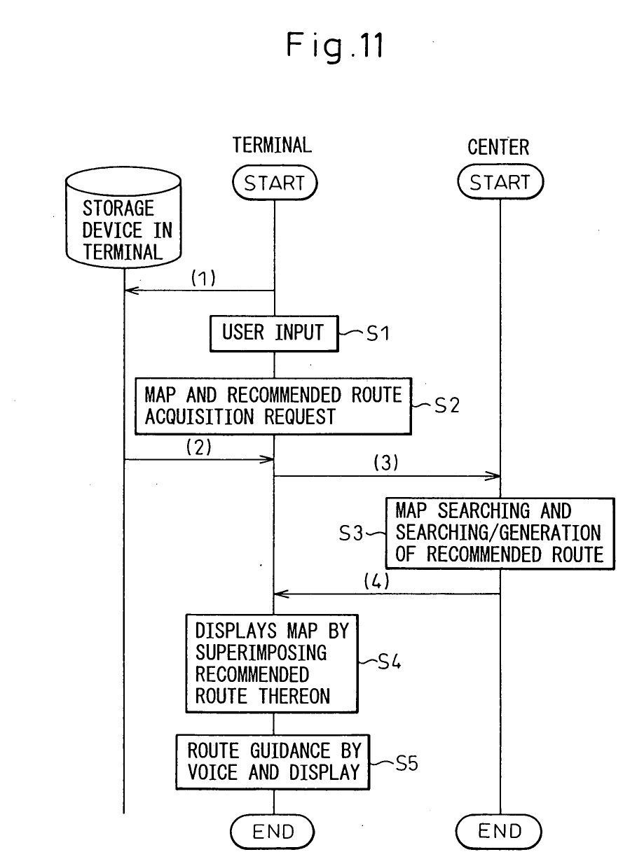

FIG. 11 is a flowchart illustrating a procedure according to the fifth embodiment. At the terminal, the routes along which the equipped vehicle has traveled in the past are recorded as they occur in the tracking data storing part 135 (FIG. 1) of the terminal ((1)). When the user inputs the present vehicle position and the destination from the input device 15 of the terminal (S1) and requests the center for transmission of a map and a recommended route (S2), a file recording the routes along which the equipped vehicle has traveled in the past is retrieved from the data storing section 13 of the terminal ((2)), and the file is transmitted to the center together with the latitudes and longitudes of the terminal's present position and the destination ((3)). The center that received these data searches for a map and a recommended route and generates a transmissive image of the recommended route (S3). At this time, the center generates the recommended route by extracting high-use routes, that is, the routes the user frequently uses, from the data received from the terminal in the form of a file recording the routes along which the equipped vehicle has traveled in the past. Then, the map and the recommended route generated in the form of a transmissive image are transmitted to the terminal ((4)). At the terminal, the recommended route is displayed by superimposing it on the map image (S4), and the route guidance is produced by voice or display (S5). If the map is already stored in the terminal, there is no need to send the map from the center.

(Embodiment 6)

In a sixth embodiment, the route portion of the map image containing routes is converted at the terminal into latitude and longitude, and the route guidance is provided by reading the latitude and longitude.

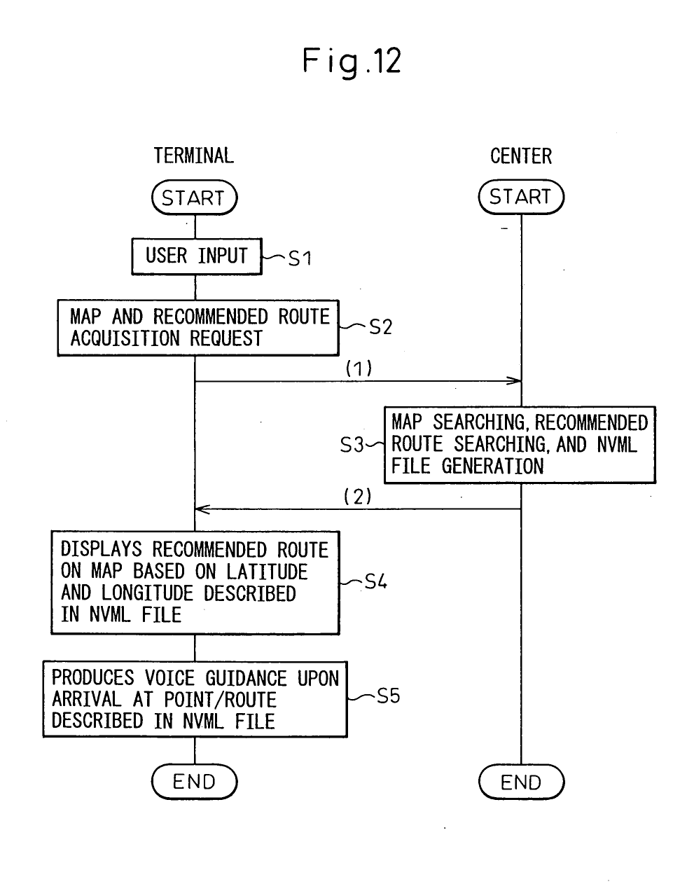

FIG. 12 is a flowchart illustrating a procedure according to the sixth embodiment. First, the user inputs the present position of the terminal and the desired destination from the input device 15 of the terminal 1 (S1), and requests the center for transmission of a map and a recommended route (S2). This request is transmitted from the control section 12 to the center 2 over the network via the communication section 11, together with the latitudes and longitudes of the terminal's present position and the destination ((1)). The center 2 receives these data by the communication section 21 and transfers the data to the map searching section 23 and the route searching section 25. The map searching section 23, based on the latitudes and longitudes of the present position and the destination, searches the map database 22 for a map of the region containing the present position and the destination, while the route searching section 25, based on the latitudes and longitudes of the present position and the destination, searches for a recommended route, and an NVML file containing the route information is generated (S3). The retrieved map and the NVML file containing the route information are transmitted to the terminal ((2)).

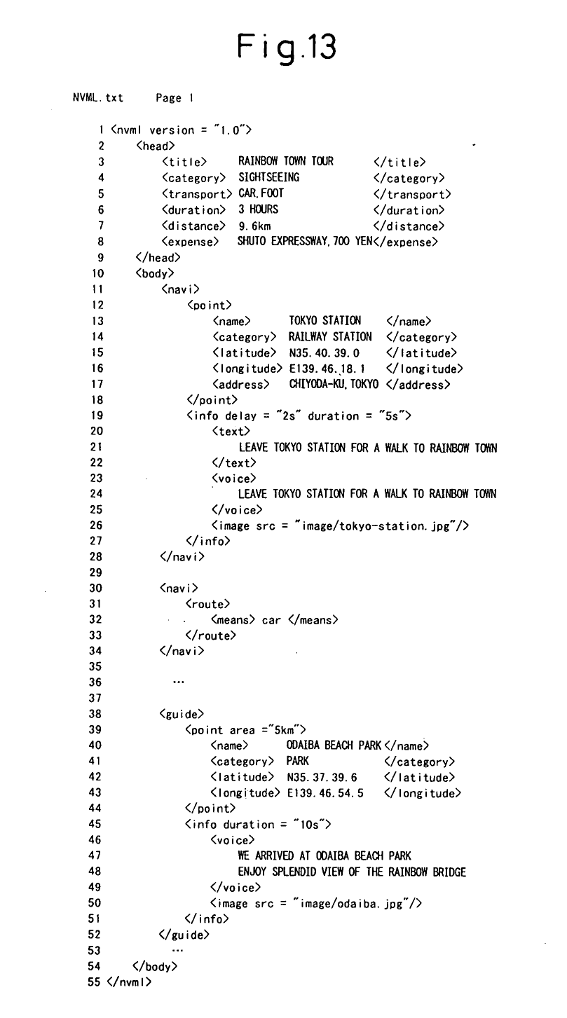

FIG. 13 is a diagram showing an example of the NVML file. In the figure, <head> element describes general information (header information) of the route guidance. On the other hand, <body> element describes the details of the route guidance, and comprises <navi> element and <guide> element sequences. As the vehicle passes the points and routes specified in the <navi> element sequence in sequence and approaches the point specified in the <guide> element, the route data described in NVML outputs the guide information accordingly. The <navi> element describes information concerning all the intermediate points and routes along the recommended route, and comprises <point> element or <route> element, each element containing latitude and longitude information. As the vehicle passes the point described in the <point> element or the route described in the <route> element in sequence, and reaches the specified point or the specified route, the guidance information described in the corresponding <info> element is output. The <guide> element describes information concerning guide points such as a shop or a sightseeing spot along the route, and comprises <point> element and <info> element. As the vehicle approaches the point described in the <point> element, the guidance information described in the <info> element is output. In this way, the NVML can describe the routes from the present position to the destination, sightseeing spots along the routes, travel schedules, etc. in standardized format by linking the point and route information to their associated guidance information (from “Introduction to NVML” at http://www.labs.fujitsu.com/theme/nvml/).

Turning back to FIG. 12, when the map and the NVML file are received at the terminal, the NVML file is analyzed by the NVML file analyzer, and the recommended route is displayed on the map, based on the latitude and longitude in the route information described in the file (S4). Then, when the vehicle reaches each point or route specified by the latitude and longitude described in the NVML file, guidance information is produced by voice or other suitable means (S5).

(Embodiment 7)

In a seventh embodiment, a map image with a route written thereon is stored in the terminal by dividing the image into a route portion and a map portion.

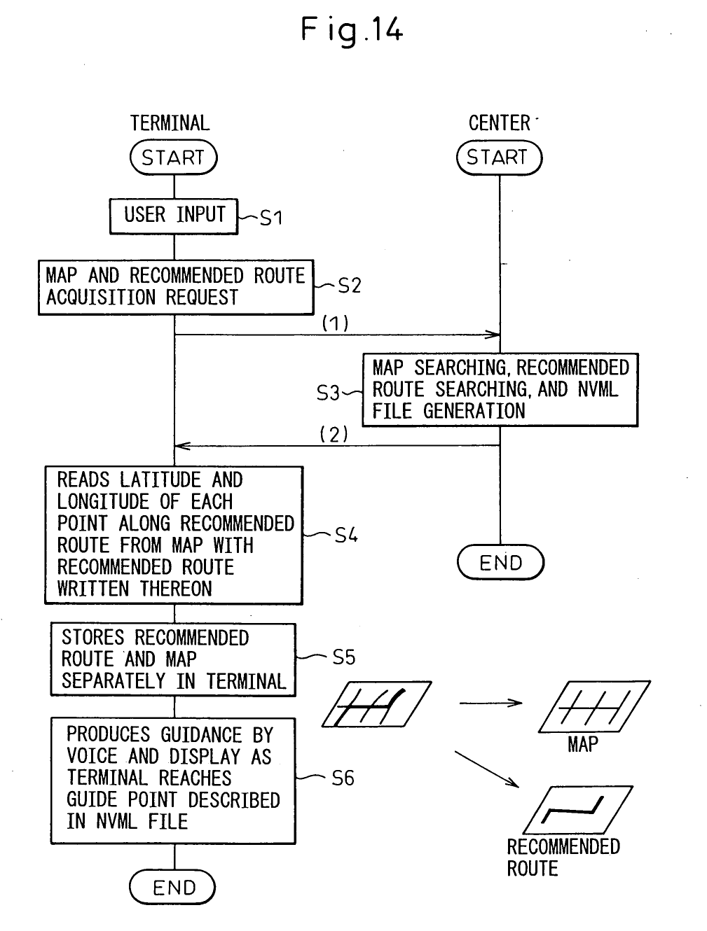

FIG. 14 is a flowchart illustrating a procedure according to the seventh embodiment. The user inputs the present position of the terminal and the desired destination (S1), and requests the center for transmission of a map and a recommended route (S2), and this request is transmitted to the center 2 over the network, together with the latitudes and longitudes of the terminals present position and the destination ((1)); the procedure up to this point is the same as that shown in the flowchart of FIG. 12.

The center 2 receives these data by the communication section 21 and transfers the data to the map searching section 23, the route searching section 25, and the NVML file generating section 26. The map searching section 23, based on the latitudes and longitudes of the present position and the destination, searches the map database 22 for a map of the region containing the present position and the destination, while the route searching section 25, based on the latitudes and longitudes of the present position and the destination, searches for a recommended route, and a map image with the recommended route written thereon is generated. On the other hand, the NVML file generating section 26 generates an NVML file containing the route information in which the latitudes and longitudes described in the <route> elements are not written, but only the latitudes and longitudes of the points described in the <point> elements, for example, the latitudes and longitudes of intersections and turns, are written (S3). The map image and the NVML file are then transmitted to the terminal ((2)).

The terminal that received them reads the latitude and longitude of each point along the recommended route from the map with the recommended route written thereon (S4), and stores the map and the recommended route separately, the former in the map image information storing part 131 and the latter in the recommended route storing part 136, in the data storing section of the terminal (S5). In the meantime, as the vehicle reaches the guide point specified in each <point> element described in the NVML file, route guidance is produced by voice (S6). The map and the recommended route stored in S5 are reused when the equipped vehicle travels along the same route at some later time.

(Embodiment 8)

In an eighth embodiment, when transmitting a map image with the recommended route written on the map, a map image of only the region in the vicinity of the recommended route is transmitted.

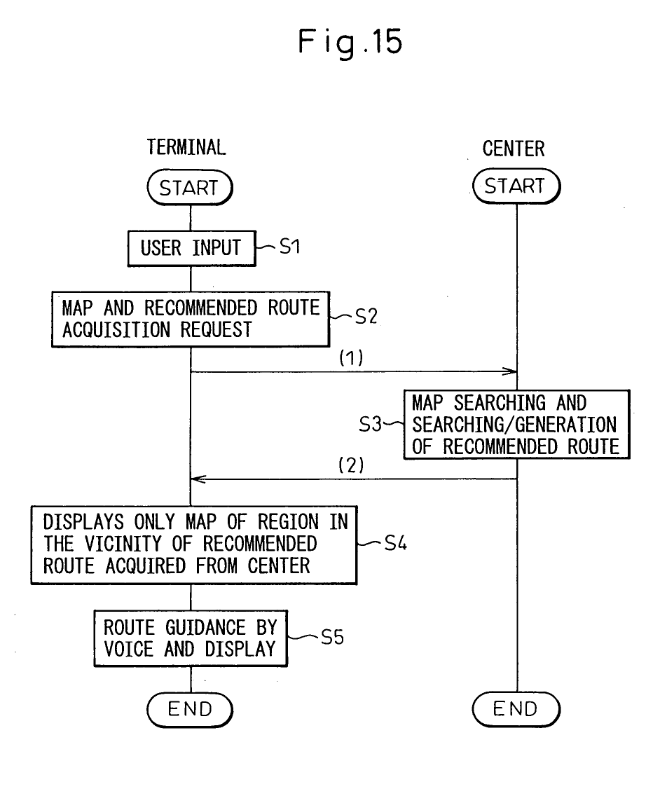

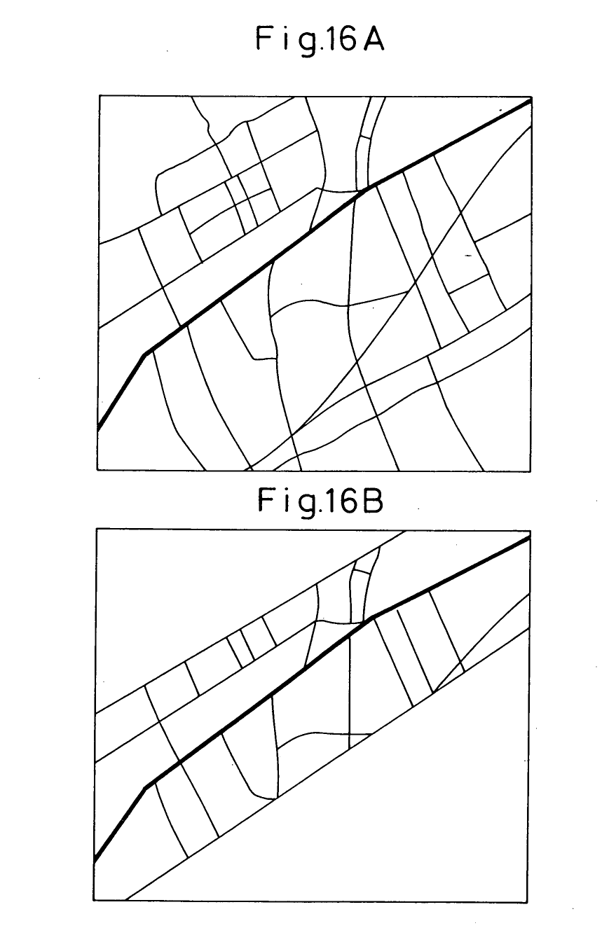

FIG. 15 is a flowchart illustrating a procedure according to the eighth embodiment. The procedure up to the point ((1)) where the request for a map and a recommended route is transmitted from the terminal to the center, together with the latitudes and longitudes of the terminals present position and the destination, is the same as that shown in the flowchart of FIG. 2. At the center that received these data, a search is made for a map of the region containing the present position and the destination, a search is made for a route based on the latitudes and longitudes of the present position and the destination, and the map containing the recommended route, shown in FIG. 16A, is generated (S3). Next, the center transmits map data to the terminal by extracting only the map of the region in the vicinity of the recommended route, shown in FIG. 16B, from the map containing the recommended route ((2)). The terminal that received the map displays the map only of the region in the vicinity of the recommended route (S4), and produces route guidance by voice and display (S5).

(Embodiment 9)

In a ninth embodiment, when using a map previously acquired and stored in the storage device of the terminal, a list of the maps stored in the storage device is transmitted to the center which then searches for a recommended route by preferentially using the maps carried in the list.

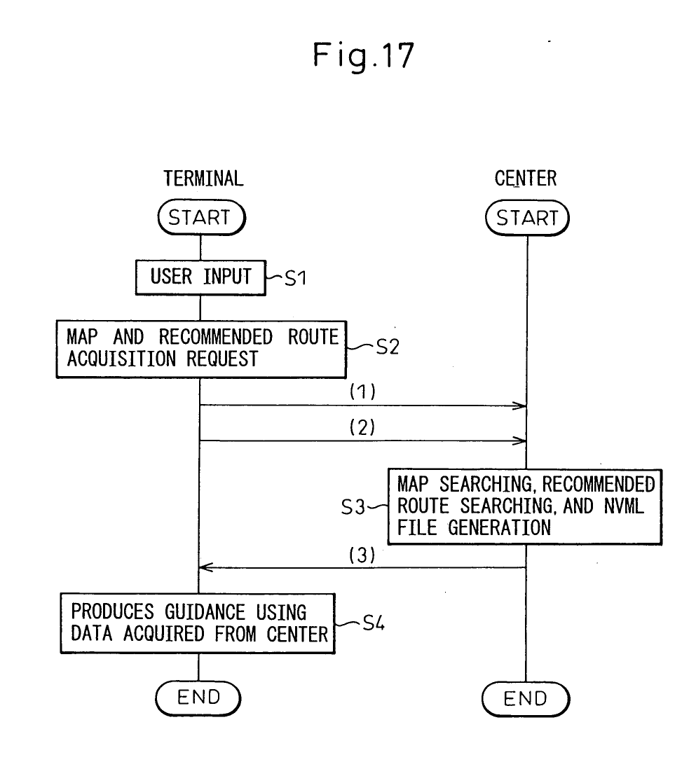

FIG. 17 is a flowchart illustrating a procedure according to the ninth embodiment. First, the user inputs the present position of the terminal and the desired destination from the input device 15 of the terminal 1 (S1), and requests the center for transmission of a map and a recommended route (S2). This request is transmitted from the control section 12 to the center 2 over the network via the communication section 11, together with the latitudes and longitudes of the present vehicle position and the destination ((1)). At the same time, the list of the maps stored in the storage device is transmitted from the terminal to the center ((2)). The center 2 receives these data by the communication section 21 and transfers the data to the map searching section 23 and the route searching section 25. The map searching section 23, based on the latitudes and longitudes of the present position and the destination, searches the map database 22 for a map of the region containing the present position and the destination. The route searching section 25, based on the latitudes and longitudes of the present position and the destination, searches for a recommended route, and an NVML file containing the route information is generated (S3). The retrieved map and the NVML file containing the route information are transmitted as separate files to the terminal ((3)). In this case, the route search is performed by preferentially using the maps carried in the list. For example, if there is more than one route, a search is made through the routes on the maps carried in the list. Then, a map, if not carried in the list, and the NVML file containing the route information are transmitted to the terminal ((3)). The terminal produces the route guidance based on the information obtained from the center (S4).

(Embodiment 10)

In a tenth embodiment, when the system is configured such that the map data and a transmissive image carrying only text information are transmitted from the center to the terminal and displayed on the terminal by superimposing one on the other, the direction in which the vehicle equipped with the terminal is heading is transmitted to the center so that the text information will always be displayed horizontally on the display screen even when the orientation of the map changes with a change in the heading direction to keep the vehicle heading direction pointing straight up (heading up) on the display screen.

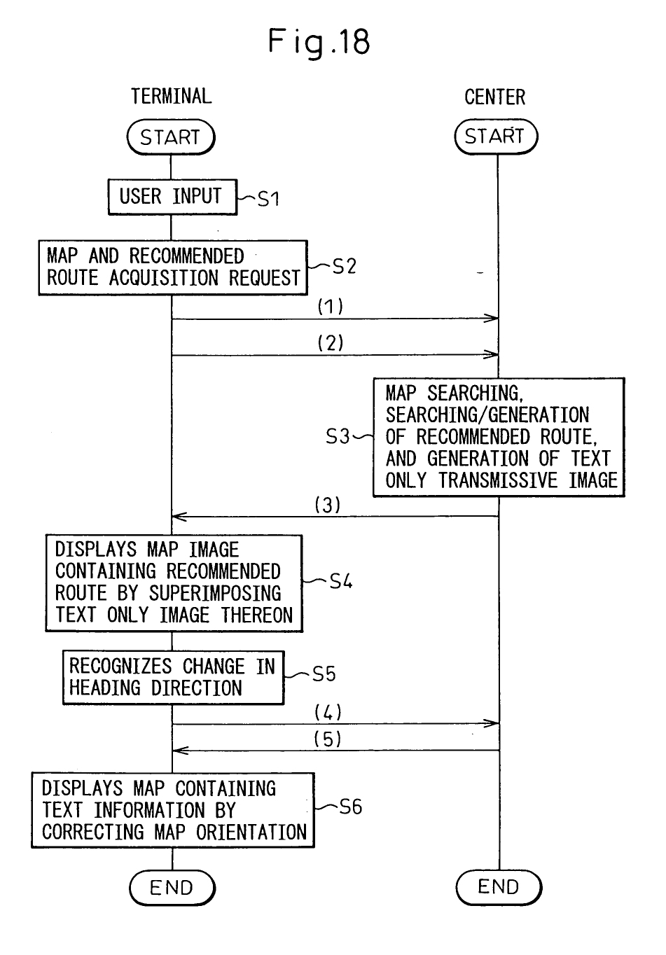

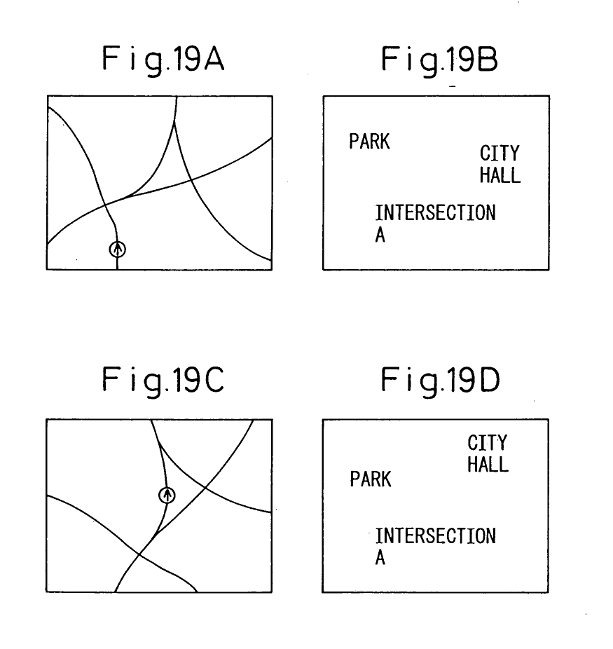

FIG. 18 is a flowchart illustrating a procedure according to the 10th embodiment. First, the user inputs the present position of the terminal and the desired destination from the input device 15 of the terminal 1 (S1), and requests the center for transmission of a map and a recommended route (S2). This request is transmitted from the control section 12 to the center 2 over the network via the communication section 11, together with the latitudes and longitudes of the terminal's present position and the destination ((1)). At the same time, the direction in which the vehicle equipped with the terminal is heading is also transmitted from the terminal to the center ((2)). The center 2 receives these data by the communication section 21 and transfers the data to the map searching section 23 and the route searching section 25. The map searching section 23, based on the latitudes and longitudes of the present position and the destination, searches the map database 22 for a map of the region containing the present position and the destination. The route searching section 25, based on the latitudes and longitudes of the present position and the destination, searches for a recommended route, and a heading-up map on which the vehicle heading direction, including the recommended route, always points straight up, as shown in FIG. 19A, is generated (S3). At the same time, a transmissive image carrying only text information such as the names of facilities, etc., as shown in FIG. 19B, is generated as a separate file. Then, the map containing the recommended route and the transmissive image carrying only the text information are transmitted to the terminal ((3)).

The terminal that received these pieces of information displays the image carrying only the text information, by superimposing it on the map containing the recommended route (S4). When the vehicle heading direction changes during the route guidance, the terminal recognizes this change (S5), and transmits the vehicle heading direction to the center ((4)). In response, the center transmits a heading-up map corrected for the change of the heading direction, such as shown in FIG. 19C, together with the transmissive image of FIG. 19D carrying only the text information and corrected so as to display the text information horizontally on the screen regardless of the change of the orientation of the map on the screen, and the text information is superimposed on the map for display (S6).

What is claimed is:

1. A method for route guidance in which terminal equipment transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
when the terminal equipment recognizes that the present position of the terminal equipment is off the recommended route, the terminal equipment transmits the present position to the central apparatus, receives information of a recommended route newly searched for by the central apparatus, and displays the new recommended-route information together with the already received map image information.

2. A method for route guidance in which terminal equipment transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
the terminal equipment transmits the present position of the terminal equipment to the central apparatus at predetermined intervals of time and, when the central apparatus recognizes that the present position is off the route, the terminal equipment receives, from the central apparatus, information of a recommended route newly searched for based on the present position, and displays the new recommended-route information together with the already received map image information.

3. A method for route guidance in which terminal equipment transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
when the central apparatus obtains information concerning a traffic impediment that exists on the recommended route along which the terminal equipment is moving, the terminal equipment receives image information of a recommended route newly searched for and generated by the central apparatus so as to detour around the traffic impediment, and the terminal equipment displays the new recommended-route information together with the already received map image information.

4. A method for route guidance as claimed in any one of claims 1 to 3, wherein of the information concerning the recommended route newly searched for by the central apparatus, the terminal equipment receives only a portion not included in the original recommended-route information, and displays both the map image information and the recommended-route information.

5. A method for route guidance in which terminal equipment transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
the map image information and the recommended-route information are stored in the central apparatus by being divided into a plurality of portions, and the terminal equipment receives the divided portions in sequence based on the present position.

6. A method for route guidance as claimed in claim 5, wherein the map image information and the recommended-route information are divided at an intersection halfway along the recommended route.

7. A method for route guidance as claimed in claim 5, wherein the map image information and the recommended-route information are divided at prescribed intervals of distance along the recommended route.

8. Terminal equipment which transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
when the terminal equipment recognizes that the present position thereof is off the recommended route, the terminal equipment transmits the present position to the central apparatus, receives information of a recommended route newly searched for by the central apparatus, and displays the new recommended-route information together with the already received map image information.

9. Terminal equipment which transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
the terminal equipment transmits the present position thereof to the central apparatus at predetermined intervals of time and, when the central apparatus recognizes that the present position is off the route, the terminal equipment receives, from the central apparatus, information of a recommended route newly searched for by the central apparatus based on the present position, and displays the new recommended-route information together with the already received map image information.

10. Terminal equipment which transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
when the central apparatus obtains information concerning a traffic impediment that exists on the recommended route along which the terminal equipment is moving, the terminal equipment receives, from the central apparatus, information of a recommended route newly searched for and generated by the central apparatus so as to detour around the traffic impediment, and the terminal equipment displays the new recommended-route information together with the already received map image information.

11. Terminal equipment as claimed in any one of claims 8 to 10, wherein of the information concerning the recommended route newly searched for by the central apparatus, the terminal equipment receives only a portion not included in the original recommended-route information, and displays both the map image information and the recommended-route image information.

12. Terminal equipment which transmits the present position of the terminal equipment and a destination to a central apparatus, receives map image information from the central apparatus along with recommended-route information generated by the central apparatus and presenting a recommended route leading from the present position to the destination, and displays both the map image information and the recommended-route information, wherein
the map image information and the recommended-route information are stored in the central apparatus by being divided into a plurality of portions, and the terminal equipment receives the divided portions in sequence based on the present position.

13. Terminal equipment as claimed in claim 12, wherein the map image information and the recommended-route information are divided at an intersection halfway along the recommended route.

14. Terminal equipment as claimed in claim 12, wherein the map image information and the recommended-route information are divided at prescribed intervals of distance along the recommended route.

15. A central apparatus which receives from terminal equipment the present position of the terminal equipment and a destination, generates recommended-route information by searching for a route leading from the received present position to the destination, and transmits map image information to the terminal equipment along with the recommended-route information presenting the recommended route leading from the present position to the destination, wherein
when the terminal equipment recognizes that the present position thereof is off the recommended route, the central apparatus receives the present position transmitted from the terminal equipment, and generates and transmits information of a newly searched-for recommended route.

16. A central apparatus which receives from terminal equipment the present position of the terminal equipment and a destination, generates recommended-route information by searching for a route leading from the received present position to the destination, and transmits map image information to the terminal equipment along with the recommended-route information presenting the recommended route leading from the present position to the destination, wherein
the central apparatus receives the present position of the terminal equipment from the terminal equipment at predetermined intervals of time and, when the central apparatus recognizes that the present position is off the route, the central apparatus generates and transmits information of a recommended route newly searched for based on the present position.

17. A central apparatus which receives from terminal equipment the present position of the terminal equipment and a destination, generates recommended-route information by searching for a route leading from the received present position to the destination, and transmits map image information to the terminal equipment along with the recommended-route information presenting the recommended route leading from the present position to the destination, wherein
the central apparatus, based on information concerning a traffic impediment, newly searches for a recommended route so as to detour around the traffic impediment, and generates and transmits information of the newly searched-for recommended route.

18. A central apparatus as claimed in any one of claims 15 to 17, wherein of the information concerning the newly searched-for recommended route, the central apparatus generates and transmits only a portion not included in the original recommended-route information.

19. A central apparatus which receives from terminal equipment the present position of the terminal equipment and a destination, generates recommended-route information by searching for a route leading from the received present position to the destination, and transmits map image information to the terminal equipment along with the recommended-route information presenting the recommended route leading from the present position to the destination, wherein
the central apparatus stores therein the map image information and the recommended-route information by dividing the respective information into a plurality of portions, and transmits the divided portions in sequence based on the present position.

20. A central apparatus as claimed in claim 19, wherein the map image information and the recommended-route information are divided at an intersection halfway along the recommended route.

21. A central apparatus as claimed in claim 19, wherein the map image information and the recommended-route information are divided at prescribed intervals of distance along the recommended route.

22. A method for route guidance as claimed in claim 2, wherein the present position of the terminal equipment is transmitted from the terminal equipment to the central apparatus at appropriate intervals of time.

23. Terminal equipment as claimed in claim 9, wherein the terminal equipment transmits the present position thereof at appropriate intervals of time to the central apparatus.

24. A central apparatus as claimed in claim 16, wherein the central apparatus receives the present position of the terminal equipment at appropriate intervals of time from the terminal equipment.

25. A method for route guidance as claimed in any one of claims 1 to 3, wherein the map image information and the recommended-route information generated by the central apparatus and presenting the recommended route from the present position to the destination are received as separate files.

26. Terminal equipment as claimed in any one of claims 8 to 10, wherein the map image information and the recommended-route information generated by the central apparatus and presenting the recommended route from the present position to the destination are received as separate files.

27. A central apparatus as claimed in any one of claims 15 to 17, wherein the map image information and the recommended-route information presenting the recommended route from the present position to the destination are transmitted as separate files to the terminal equipment.

28. A method for route guidance in which terminal equipment transmits the present position of the terminal equipment and a destination to a central apparatus, receives map image information from the central apparatus along with recommended-route information generated by the central apparatus and presenting a recommended route leading from the present position to the destination, and displays the map image information and the recommended-route information by superimposing one onto the other, wherein
when the terminal equipment transmits the present position thereof and the destination to the central apparatus, the terminal equipment also transmits routes that the terminal equipment has passed in the past, and receives the recommended-route information that the central apparatus generated by considering the frequency of use of the routes.

29. A method for route guidance in which terminal equipment transmits the present position of the terminal equipment and a destination to a central apparatus, and receives, from the central apparatus, map image information generated by the central apparatus by writing on a map a recommended route leading from the present position to the destination, wherein
the terminal equipment receives only a map of a region in the vicinity of the recommended route that the central apparatus extracted from the map image information.

30. Terminal equipment comprising: a position detecting section for detecting the present position of the terminal equipment; a communication section for communicating with a central apparatus; a map image information storing section for storing map image information received via the communication section from the central apparatus; and a map image information combining section for combining the image information with recommended-route information received via the communication section from the central apparatus, wherein, when the position detecting section detects that the present position is off the route, the map image information combining section receives image information of a recommended route newly searched for by the central apparatus, and combines the new recommended-route image information with the already received map image information.

31. A central apparatus comprising: a communication section for communicating information to and from terminal equipment; a map database having map image information stored therein; and a route searching section for searching for a recommended route based on the present position of the terminal equipment and a destination received via the communication section, wherein information of the recommended route searched for by the route searching section is transmitted along with the map image information retrieved from the map database and, when the communication section receives information indicating that the terminal equipment has deviated from the recommended route, information of a newly searched-for recommended route is transmitted from the communication section without re-transmitting the map image information.
